(19) United States
(12) Patent Application Publication
(10) Pub. No.: US 2021/0088204 A1
(43) Pub. Date: Mar. 25, 2021

(54) ILLUMINATING APPARATUS

(71) Applicant: Dong Guan Jia Sheng Lighting Technology Co., Ltd. China, Guang-Dong (CN)

(72) Inventor: Kevin Hsu, Taichung (TW)

(21) Appl. No.: 16/581,868

(22) Filed: Sep. 25, 2019

(51) Int. Cl. F21V 23/02; F21S 6/00; F21S 8/00; F21S 8/06; F21S 9/02; F21V 23/00; F21V 33/00; F21V 21/08; H02J 7/00; H02J 7/02

(52) U.S. Cl. CPC F21V 23/02; F21S 6/002; F21S 8/032; F21S 8/033; F21S 8/061; H02J 7/025; F21V 23/003; F21V 33/0056; F21V 21/0824; F21S 6/005; H02J 7/0045; F21S 9/02

(57) ABSTRACT

An illuminating apparatus includes a support mechanism, an electric power system mounted on the support mechanism, and a sound and lamp assembly placed on the electric power system. The sound and lamp assembly includes a mounting rack, a lighting module, an acoustics module, a control circuit board, and a battery. Thus, the electric power system directly charges the sound and lamp assembly. In addition, the sound and lamp assembly includes a detection module that detects the charged state of the sound and lamp assembly, and regulates the lighting brightness according to the charged state, thereby prolonging the working time of the sound and lamp assembly after the sound and lamp assembly is removed from the electric power system.

### BACKGROUND OF THE INVENTION

### 1. Field of the Invention

The present invention relates to an illuminating apparatus.

### 2. Description of the Related Art

A conventional sound lamp comprises a sound unit and a lighting unit. Thus, the conventional sound lamp provides a acoustical function and an illuminating function to enhance the versatility thereof. However, it is necessary to connect an external USB electric wire to charge the conventional sound lamp, such that the conventional sound lamp is not charged directly. In addition, the brightness of the conventional sound lamp cannot be regulated according to the practical working condition.

### BRIEF SUMMARY OF THE INVENTION

In accordance with the present invention, there is provided an illuminating apparatus comprising a support mechanism, an electric power system mounted on the support mechanism, and a sound and lamp assembly placed on the electric power system. The electric power system charges the sound and lamp assembly. The sound and lamp assembly is operated individually when the sound and lamp assembly is removed from the electric power system. The sound and lamp assembly includes a mounting rack, a lighting module mounted on the mounting rack, an acoustics module mounted on the mounting rack, a control circuit board mounted on the mounting rack, and a battery mounted on the mounting rack. The electric power system charges the battery of the sound and lamp assembly when the sound and lamp assembly is placed on the electric power system. The control circuit board of the sound and lamp assembly is electrically connected with the lighting module, the acoustics module, and the battery. The control circuit board of the sound and lamp assembly controls operation of the lighting module and the acoustics module. The control circuit board of the sound and lamp assembly includes a detection module and a control chip electrically connected with the detection module. The detection module detects a condition of the battery to produce a detection signal, and sends the detection signal to the control chip. The condition of the battery includes if the battery is disposed at a charged state. The control chip controls an electric current of the lighting module.

According to the primary advantage of the present invention, the electric power system directly charges the sound and lamp assembly, such that the sound and lamp assembly is charged easily and conveniently.

According to another advantage of the present invention, the sound and lamp assembly includes a detection module that detects the charged state of the sound and lamp assembly, and regulates the lighting brightness according to the charged state, thereby prolonging the working time of the sound and lamp assembly after the sound and lamp assembly is removed from the electric power system.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a cross-sectional view of an illuminating apparatus in accordance with the preferred embodiment of the present invention.

FIG. 2 is a cross-sectional view of an illuminating apparatus in accordance with another preferred embodiment of the present invention.

FIG. 3 is a cross-sectional view of an illuminating apparatus in accordance with another preferred embodiment of the present invention.

FIG. 4 is a cross-sectional view of an illuminating apparatus in accordance with another preferred embodiment of the present invention.

FIG. 5 is a cross-sectional view of an illuminating apparatus in accordance with another preferred embodiment of the present invention.

FIG. 6 is a planar view of an illuminating apparatus in accordance with another preferred embodiment of the present invention.

FIG. 7 is a perspective assembly view of the illuminating apparatus as shown in FIG. 6.

### DETAILED DESCRIPTION OF THE INVENTION

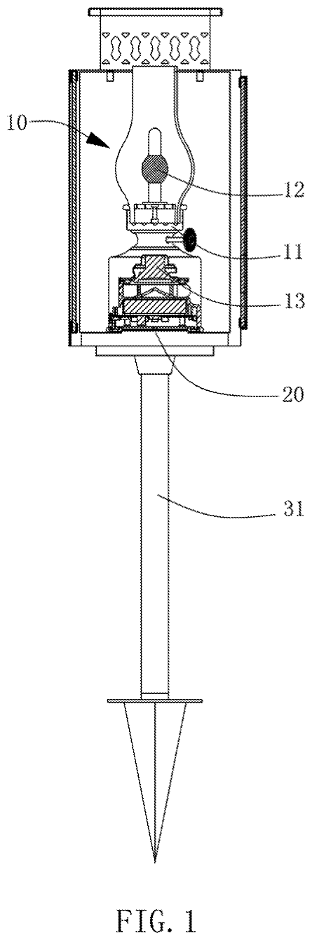

Referring to the drawings and initially to FIG. 1, an illuminating apparatus in accordance with the preferred embodiment of the present invention comprises a support mechanism, an electric power system (or a power supply) 20 mounted on the support mechanism, and a sound and lamp assembly 10 placed on the electric power system 20.

The electric power system 20 charges the sound and lamp assembly 10. The sound and lamp assembly 10 is operated individually when the sound and lamp assembly 10 is removed from the electric power system 20. The sound and lamp assembly 10 includes a mounting rack 11, a lighting module 12 mounted on the mounting rack 11, an acoustics module 13 mounted on the mounting rack 11, a control circuit board mounted on the mounting rack 11, and a battery mounted on the mounting rack 11. The electric power system 20 charges the battery of the sound and lamp assembly 10 when the sound and lamp assembly 10 is placed on the electric power system 20. The mounting rack 11 is mounted on the electric power system 20. The control circuit board of the sound and lamp assembly 10 is electrically connected with the lighting module 12, the acoustics module 13, and the battery. The control circuit board of the sound and lamp assembly 10 controls operation of the lighting module 12 and the acoustics module 13. The control circuit board of the sound and lamp assembly 10 includes a detection module and a control chip electrically connected with the detection module. The detection module detects a condition of the battery to produce a detection signal, and sends the detection signal to the control chip. The condition of the battery includes if the battery is disposed at a charged state. The control chip controls the input current and the output current of the lighting module 12, so as to regulate the brightness of the lighting module 12.

In practice, when the sound and lamp assembly 10 is placed on the electric power system 20, the brightness of the lighting module 12 is disposed at the state of 100%, and when the sound and lamp assembly 10 is removed from the electric power system 20, the brightness of the lighting module 12 is disposed at the state of 70%.

In the preferred embodiment of the present invention, the electric power system 20 includes a circuit board, a charging device, and a charging connector. An external circuit is electrically connected with the circuit board of the electric power system 20 by USB or by direct connection. The charging device of the electric power system 20 is electrically connected with the circuit board. The sound and lamp assembly 10 includes a charging port mounted on a bottom of the mounting rack 11 and electrically connected with the battery. When the sound and lamp assembly 10 is placed on the electric power system 20, the charging connector of the electric power system 20 is electrically connected with the charging port of the sound and lamp assembly 10, to charge the battery of the sound and lamp assembly 10.

In the preferred embodiment of the present invention, the electric power system 20 includes a wireless charging structure having a primary coil. The sound and lamp assembly 10 is provided with a secondary coil which is electrically connected with the battery. Thus, an alternating current with a determined frequency passes through the primary coil of the electric power system 20, and produces a determined electric current on the secondary coil of the sound and lamp assembly 10 through an electromagnetic induction, so as to charge the battery of the sound and lamp assembly 10.

In the preferred embodiment of the present invention, the electric power system 20 also functions as a lighting device.

In the preferred embodiment of the present invention, the support mechanism includes a ground insert 31. The ground insert 31 is inserted into the ground and has a bottom provided with a conical arrangement that tapers from top to bottom. The ground insert 31, the electric power system 20, and the sound and lamp assembly 10 construct a ground insert lamp (or garden lamp or ground light).

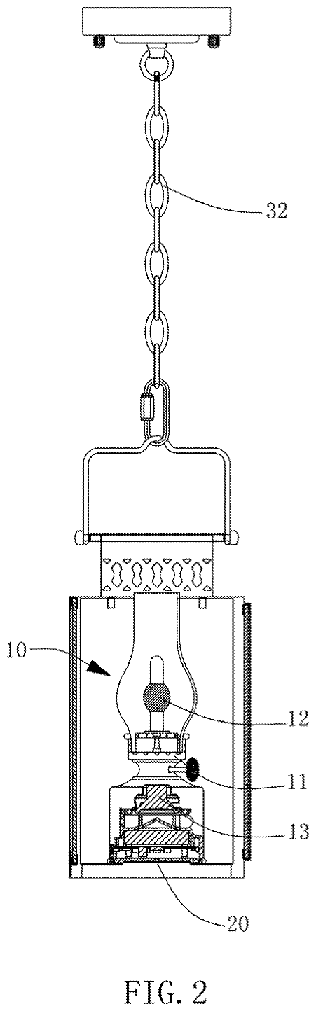

Referring to FIG. 2, the support mechanism includes a hanging portion 32 having an upper end secured to a wall (or ceiling) and a lower end connected with an upper end of the sound and lamp assembly 10. The hanging portion 32, the electric power system 20, and the sound and lamp assembly 10 construct a hanging lamp (or hanging pendant or pendant lamp).

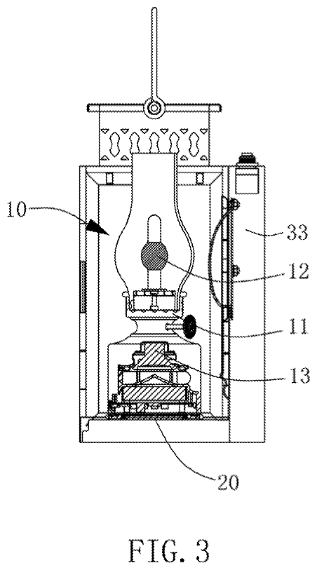

Referring to FIG. 3, the support mechanism includes a supporting bracket 33 placed on a table. The supporting bracket 33, the electric power system 20, and the sound and lamp assembly 10 construct a table lamp (or desk lamp).

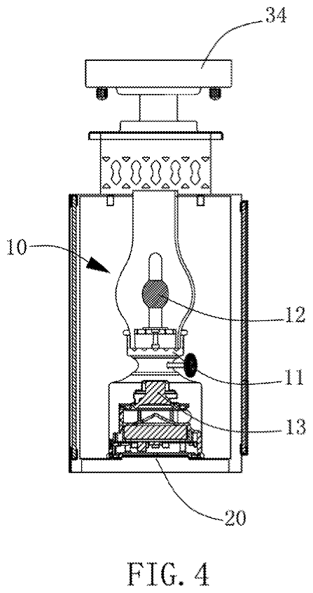

Referring to FIG. 4, the support mechanism includes a ceiling fixture 34 secured to a ceiling. The sound and lamp assembly 10 has an upper end provided with a locking member locked onto the ceiling fixture 34. The ceiling fixture 34, the electric power system 20, and the sound and lamp assembly 10 construct a ceiling lamp (or ceiling fitting).

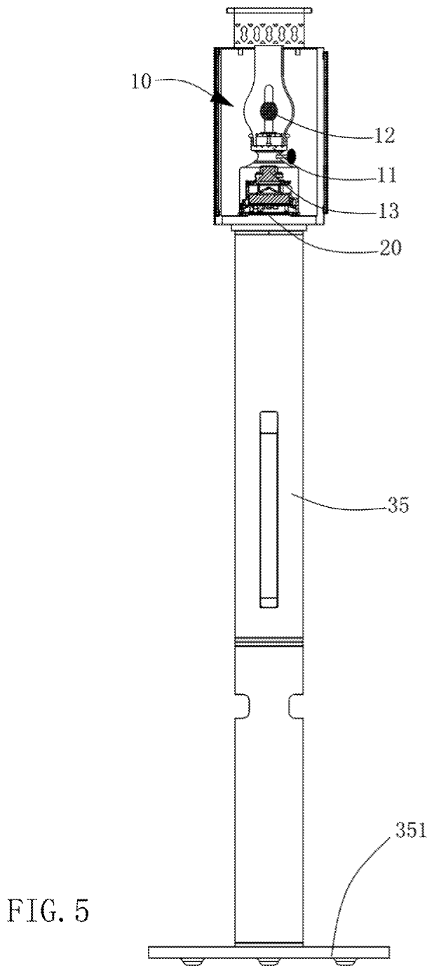

Referring to FIG. 5, the support mechanism includes a support post 35 and a base 351 mounted on a bottom of the support post 35. The support mechanism is directly placed on the floor. The support post 35, the electric power system 20, and the sound and lamp assembly 10 construct a floor lamp (or standard lamp).

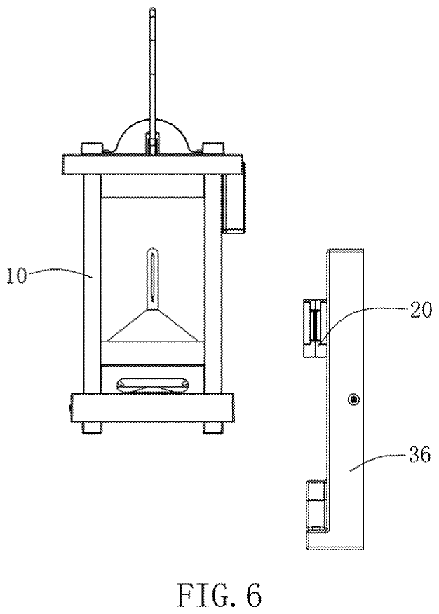

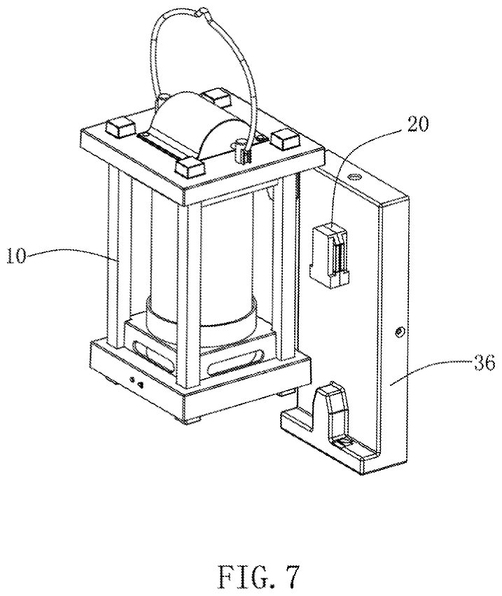

Referring to FIGS. 6 and 7, the support mechanism includes a wall seat 36 mounted on a wall. The electric power system 20 is mounted on the wall seat 36. The wall seat 36, the electric power system 20, and the sound and lamp assembly 10 construct a wall lamp (or wall fitting).

The mounting rack 11 of the sound and lamp assembly 10 has a side provided with a first locking portion. A first connecting terminal 14 is mounted on the first locking portion of the sound and lamp assembly 10 and protrudes outward from the mounting rack 11 of the sound and lamp assembly 10. The electric power system 20 is provided with a second locking portion locked onto and electrically connected with the first locking portion of the sound and lamp assembly 10. A second connecting terminal 14 is mounted on the second locking portion of the electric power system 20 and connected with the first connecting terminal 14 of the sound and lamp assembly 10.

In the preferred embodiment of the present invention, the acoustics module 13 is operated individually.

In another preferred embodiment of the present invention, the sound and lamp assembly 10 includes a plurality of acoustics modules 13 operated in combination. The acoustics modules 13 are connected to construct a combination sound system. The acoustics modules 13 include a main frame (or main engine) and an auxiliary frame (or auxiliary engine). The auxiliary frame receives an input audio signal from the main frame, decodes the input audio signal into an output audio signal, and transmits the output audio signal to a speaker which emits voice. The sound and lamp assembly 10 transmits the audio signal by Bluetooth, 2.4G, WiFi or FM.

Accordingly, the electric power system 20 directly charges the sound and lamp assembly 10, such that the sound and lamp assembly 10 is charged easily and conveniently. In addition, the sound and lamp assembly 10 includes a detection module that detects the charged state of the sound and lamp assembly 10, and regulates the lighting brightness according to the charged state, thereby prolonging the working time of the sound and lamp assembly 10 after the sound and lamp assembly 10 is removed from the electric power system 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An illuminating apparatus comprising:
a support mechanism;
an electric power system mounted on the support mechanism; and
a sound and lamp assembly placed on the electric power system;
wherein:
the electric power system charges the sound and lamp assembly;
the sound and lamp assembly is operated individually when the sound and lamp assembly is removed from the electric power system;
the sound and lamp assembly includes a mounting rack, a lighting module mounted on the mounting rack, an acoustics module mounted on the mounting rack, a control circuit board mounted on the mounting rack, and a battery mounted on the mounting rack;
the electric power system charges the battery of the sound and lamp assembly when the sound and lamp assembly is placed on the electric power system;
the control circuit board of the sound and lamp assembly is electrically connected with the lighting module, the acoustics module, and the battery;
the control circuit board of the sound and lamp assembly controls operation of the lighting module and the acoustics module;
the control circuit board of the sound and lamp assembly includes a detection module and a control chip electrically connected with the detection module;
the detection module detects a condition of the battery to produce a detection signal, and sends the detection signal to the control chip;
the condition of the battery includes if the battery is disposed at a charged state; and
the control chip controls an electric current of the lighting module.

2. The illuminating apparatus of claim 1, wherein:
the electric power system includes a circuit board, a charging device, and a charging connector;
the charging device of the electric power system is electrically connected with the circuit board;
the sound and lamp assembly includes a charging port mounted on a bottom of the mounting rack and electrically connected with the battery; and
when the sound and lamp assembly is placed on the electric power system, the charging connector of the electric power system is electrically connected with the charging port of the sound and lamp assembly, to charge the battery of the sound and lamp assembly.

3. The illuminating apparatus of claim 1, wherein the electric power system includes a wireless charging structure having a primary coil, and the sound and lamp assembly is provided with a secondary coil which is electrically connected with the battery.

4. The illuminating apparatus of claim 1, wherein:
the support mechanism includes a ground insert;
the ground insert is inserted into the ground and has a bottom provided with a conical arrangement that tapers from top to bottom; and
the ground insert, the electric power system, and the sound and lamp assembly construct a ground insert lamp.

5. The illuminating apparatus of claim 1, wherein:
the support mechanism includes a hanging portion having an upper end secured to a wall and a lower end connected with an upper end of the sound and lamp assembly; and
the hanging portion, the electric power system, and the sound and lamp assembly construct a hanging lamp.

6. The illuminating apparatus of claim 1, wherein:
the support mechanism includes a supporting bracket placed on a table; and
the supporting bracket, the electric power system, and the sound and lamp assembly construct a table lamp.

7. The illuminating apparatus of claim 1, wherein:
the support mechanism includes a ceiling fixture secured to a ceiling;
the sound and lamp assembly has an upper end provided with a locking member locked onto the ceiling fixture; and
the ceiling fixture, the electric power system, and the sound and lamp assembly construct a ceiling lamp.

8. The illuminating apparatus of claim 1, wherein:
the support mechanism includes a support post and a base mounted on a bottom of the support post;
the support mechanism is directly placed on the floor; and
the support post, the electric power system, and the sound and lamp assembly construct a floor lamp.

9. The illuminating apparatus of claim 1, wherein:
the support mechanism includes a wall seat mounted on a wall;
the electric power system is mounted on the wall seat; and
the wall seat, the electric power system, and the sound and lamp assembly construct a wall lamp.
